(19) United States
(12) Patent Application Publication
(10) Pub. No.: US 2008/0308961 A1
(43) Pub. Date: Dec. 18, 2008

(54) Rotary Pelleting Machine and Method for Producing a Multilayer Pellet

(75) Inventors: Matthias Kotzur, Berlin (DE); Wolfgang Korsch, Berlin (DE)

Correspondence Address: NORRIS, MCLAUGHLIN & MARCUS, P.A., 875 THIRD AVE, 18TH FLOOR, NEW YORK, NY, 10022, US

(73) Assignee: KORSCH AG, Berlin (DE)

(21) Appl. No.: 11/917,248

(22) PCT Filed: Jun. 23, 2006
(86) PCT No.: PCT/EP2006/063510

§ 371 Date: Dec. 12, 2007

(30) Foreign Application Priority Data
Jun. 23, 2005 (DE) 10 2005 030 312.9

(51) Int. Cl. B28B 5/06

(52) U.S. Cl. 264/113; 425/361

(57) ABSTRACT

The invention relates to a rotary pelleting machine comprising a driveable die block provided with a defined number of dies distributed over the periphery thereof, bottom rams and top rams which are associated with the dies and rotate about a common rotational axis, synchronously with the die block, along a bottom ram guide and a top ram guide, at least one filler device for filling the dies with a material to be compressed, and a compression device for acting on the rams with a compression force. According to the invention, the filler device (18) comprises at least two independently chargeable filling chambers (24) which can be successively brought into a defined filling position. The invention also relates to a method for producing a multi-layer pellet by means of a rotary pelleting machine.

The invention relates to a rotary pelleting machine and method for producing a multilayer tablet.

Rotary pelleting machines are commonly known. A rotor of the rotary pelleting machine is set into rotation using a drive machine. The rotor includes dies arranged along a periphery which are associated with top plungers and bottom plungers. The dies are filled with a material to be pressed via at least one feed shoe and, depending on the angular position of the rotor, the bottom plungers and top plungers, which are guided via guide tracks, move axially with respect to the dies. The bottom and top plungers pass at least one pressing station, typically a pre-pressing station and a main pressing station. The top and bottom plungers are controllably guided past stationary pressure rollers, so that a pressing force can be applied to the material to be pressed introduced into the dies.

Rotary pelleting machines are known which can be used to produce so-called multilayer tablets, i.e., tablets containing several layers and/or inserts. Several feed devices and pressing stations are sequentially arranged along the periphery of the rotor. The rotor must therefore have a correspondingly large circumference which depends on the number of layers and/or inserts. Consequently, a rotary pelleting machine requires a large installation space.

Conventional rotary pelleting machines operate very inefficiently, in particular, when producing small quantities of multilayer tablets, for example in laboratory-type production setting or for tests pressings.

It is therefore an object of the invention to provide a rotary pelleting machine of the aforedescribed type and a method for producing a multilayer tablet, which can be used to produce multilayer tablets in a simple manner, and more particularly also in small quantities.

The object is attained with the invention with a rotary pelleting machine having the features recited in claim 1 and a method for producing a multilayer tablet with the features recited in claim 16.

Advantageously, a rotary pelleting machine for the production of multilayer tablets with a small footprint can be constructed by employing a filling apparatus with at least two filling chambers that can be filled independent of one another, wherein the filling chambers can be moved sequentially to a defined filling position, wherein preferably the filling chambers can be continuously and sequentially brought into the filling position during the rotation of the die block. A corresponding layer or an insert of the multilayer tablet can produced or brought into position during each complete revolution of the die block (rotor) by moving the filling chambers which can be filled independently of one another sequentially into the filling position. As a result, particularly the circumference of the die block can be reduced to the minimum dimension necessary to fill and press (optionally pre-press and main-press) the dies. This approach obviates the need for producing and positioning the layers and the inserts, respectively, sequentially during a revolution of the die block. The number of dies and plunger pairs is also reduced significantly. More particularly, such small-size rotary pelleting machines can be used as laboratory machines or test machines.

According to an advantageous embodiment of the invention, the filling apparatus includes several, i.e., at least two, sequential chambers which can be accessed individually (sequentially). The chambers are filled under production conditions. Filling and sequential addressing are hereby integrated into the temporal sequences of the overall process. Accordingly, one chamber is always brought into the filling position, thereby providing a continuous process flow.

According to another advantageous embodiment of the invention, the filling apparatus is a rotatable chamber feed shoe with at least two filling chambers. The individual layers or inserts can then be advantageously produced by a simple rotation of the chamber feed shoe about a defined angle. The chamber feed shoe is hereby rotated during a revolution of the filled die, so that the next layer can be supplied via the rotatable chamber feed shoe once die with the pressed first layer reaches the filling position. Depending on the number of chambers, The number of multilayer tablets with layers or inserts that can be produced depend on the number of chambers. The chamber feed shoe has preferably six filling chambers which are arranged in star-shape about a rotation axis of the chamber feed shoe. Preferably, all chambers except for one are used for filling the dies, whereas one chamber, the logically last chamber of the chamber feed shoe, is preferably used for removing the pressed multilayer tablet. The last (sixth) chamber allows in the open contour the tablets to be raised up to the ejection point (part of the lower curve section adapted for motor-driven adjustment) between filling/metering and pressure roller (maximizing the length of the ejection trajectory). The chamber feed shoe is preferably moved by a drive which continuously combines a linear motion and a rotary motion, allowing a deep intrusion into the die reference circle and thereby maximizing the filling path.

According to another advantageous embodiment of the invention, the pressing device of the rotary pelleting machine includes a main pressure roller pair. The pressure rollers are preferably arranged so as to be adjustable in height with respect to the die block. The pressing force with respect to the filling height in the dies, which in turn depends on the number and the thickness of the individual layers or inserts, can then be set accurately. Preferably, the height of the pressure rollers is adjusted by using corresponding drives, in particular servo motors, pneumatic drives and the like. The pressure rollers can be accurately positioned with the help of a distance measurement system adapted to transmit data. With the employed drives, positioning becomes extremely fast, highly accurate and repeatable.

In another advantageous embodiment of the invention, the guide tracks for the bottom plungers and/or top plungers are height-adjustable relative to the die block. Preferably, different segments of the guide tracks can be adjusted in height independent of one another. In this way, the plunger stroke of the top plunger and/or the bottom plunger for the multilayer tablet to be produced can be set to take into consideration the already pressed layers. In addition, the finished pressed multilayer tablet can be easily removed. Preferably, the guide rails and the individual segments of the guide rails, respectively, are controlled with corresponding drives. The guide rails can be positioned accurately by employing a distance measurement system adapted to return data. With the employed drives, positioning becomes extremely fast, highly accurate and repeatable.

According to an advantageous embodiment, only a single plunger pair associated with the die to be filled is provided. The additional dies of the die block are preferably implemented as dummy dies.

Additional advantageous embodiments of the invention are recited as additional features in the dependent claims.

Exemplary embodiments of the invention will now be described in more detail with reference to the appended drawings.

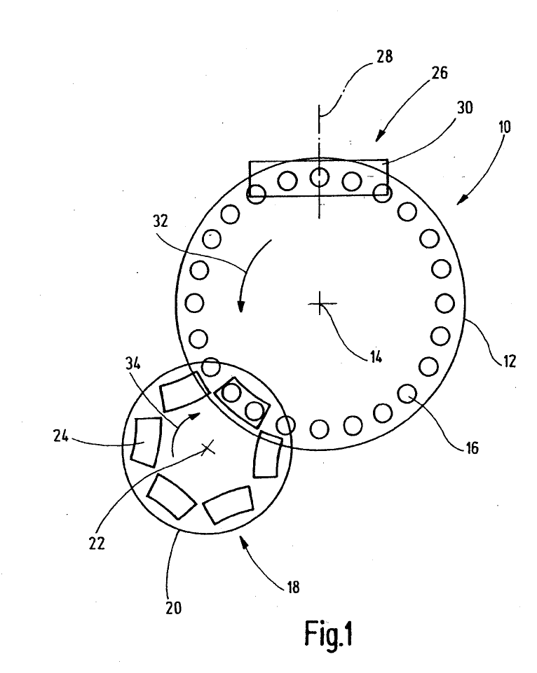

FIG. 1 shows a schematic top view on a rotary pelleting machine;

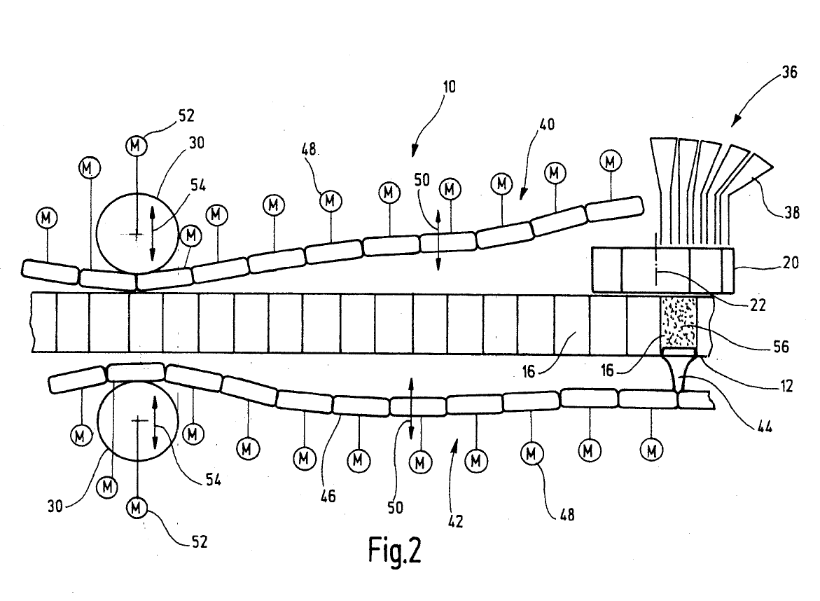

FIG. 2 shows schematically the developed view of a rotor of a rotary pelleting machine; and

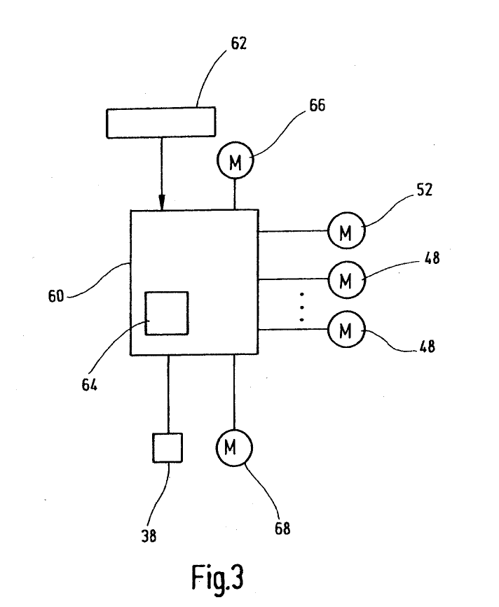

FIG. 3 shows a schematic block diagram for controlling a rotary pelleting machine.

Rotary pelleting machines are generally known, so that details of their construction and functionality will not be described in the context of the following description. Only the components which are important for the invention will be described.

A rotary pelleting machine 10 includes a die block 12, which can be rotated by a drive (not shown), typically an electric motor, about an axis 14. The die block 12 includes an on its periphery a number of dies 16. The number of dies 16 depends on a diameter of the die block 12 and/or a diameter of the dies 16. A plunger pair (also not shown in FIG. 1) formed by a top plunger and a bottom plunger is associated with at least one of the dies 16.

The rotary pelleting machine 10 also includes a filling apparatus, indicated with the reference symbol 18, which is configured as a chamber feed shoe 20. The chamber feed shoe 20 includes several, in this case six, filling chambers 24 which are arranged symmetrically about a rotation axis 22. The chamber feed shoe 20 can be rotated by a drive (not shown in FIG. 1) in predetermined angular steps or continuously about the rotation axis 22.

The rotary pelleting machine 10 further includes a pressing device 26 with pressure rollers 30 which are rotatably supported about a rotation axis 28. One of the pressure rollers 30 is hereby arranged above the die block 12, whereas another pressure roller 30 is arranged below the die block 12.

The rotary pelleting machine illustrated in FIG. 1 performs the following functions:

The individual filling chambers 24 of the chamber feed shoe 20 are filled with different materials to be pressed by a filling apparatus (not shown). The material filled into the individual filling chambers depends on the intended layer configuration of the multilayer tablets to be produced. Repeating layers can be made of the same pressed material. Exactly one filling chamber of the filling chambers 24 is always positioned in a filling position. This filling position is attained when the dies of the guide block to be filled rotate below past the filling chamber 24 which is in the filling position. For producing small quantities of multilayer tablets, for example in a laboratory experiment or for test pressings, only a single or optionally a small number of adjacent dies 16 are filled. All other dies 16 of the die block 12 are configured as dummy dies, which cannot be filled. Optionally, the die block 12 has only one or a small number of adjacent dies 16.

The die block 12 rotates about the rotation axis 14, whereby the corresponding die 16 is filled. The height is defined by the position of the corresponding associated bottom plunger. The material introduced into the dies 16 via a first filling chamber 24 is pressed by rotating the die block 12 and the bottom and top plungers, respectively, associated with the dies. The bottom and top plungers are hereby guided past the pressure rollers 13 in a conventional manner. When the filled die 16 is rotated by one revolution of the die block 12, i.e., by 360° (in the direction of arrow 32), the chamber feed shoe 20 is rotated about its rotation axis 22 in the direction of arrow 34. In this way, the next filling chamber 24 reach is the filling position. The die 16, which now includes the first layer of the multilayer tablet, is then filled with the material to be pressed residing in the next filling chamber 24. wherein the filling height can be defined yet again by positioning of the associated bottom plunger accordingly. In the subsequent rotation of the die block 12, the second layer of the multilayer tablet is again pressed with the pressure rollers 30 of the pressing device 26. The height of the guides for the bottom and top plungers and/or the pressure rollers 30 can be adjusted relative to the plane of the die block 12 in a manner to be described below. In this way, a precise desired pressing result can be attained in conjunction with the desired pressing forces and layer thicknesses.

Likewise, the additional layers of the multilayer tablet, i.e., six layers with a chamber feed shoe 20 having six filling chambers 24, can be produced after six revolutions of the die block 12.

Stated differently, a multilayer tablet with six layers can be produced after six revolutions of the die block 12 when one die 16 is filled. If two, three or four adjacent dies 16 are filled, a corresponding number of multilayer tablets can be produced during a sixfold revolution of the die block 12.

It will be understood that less or more layers of a multilayer tablet can be produced by using a chamber feed shoe 20 with a corresponding number of filling chambers 24, i.e., more or less than six. Moreover, certain filling chambers 24 may not be filled, so that no material to be pressed is supplied when the dies 16 pass the filling chambers 24 in the filling position.

When the multilayer tablets to be produced are fully pressed, they are ejected from the dies 16. To this end, the corresponding bottom plungers are moved into a corresponding ejection position, so that the tablets can be removed with a stripper (not shown). According to another embodiment, one of the filling chambers 24, such as the logically last filling chamber 24, can be used as ejector. The periphery of this filling chamber 24 facing the circumference of the chamber feed shoe 20 is thereby open and forms the ejector when this peripherally open filling chamber (also ejector chamber) is in the filling position. According to another embodiment, the logically last chamber is not used as an ejector, but allows due to the open contour of the chamber the tablets to be raised to the ejection point between metering/filling and pressure roller. The tablet is raised by adjusting the lower plunger guide, which will be described below. Overall, this results in a longer ejection trajectory. Additional approaches known in the art, such as blowing or suctioning the pressed multilayer tablets out, may also be contemplated. The respective end of the filter chambers can also be used to remove the completed multilayer tablet from the machine. This would obviate the need for additional strippers.

FIG. 2 shows schematically the developed view of a die block 12 of a rotary pelleting machine 10. The die block 10 includes the schematically indicated dies 16. As described above, when used as a laboratory machine, only one or a small number of adjacent dies 16 are filled. The other dies 16 are either implemented as dummy dies or not at all.

Also indicated is the chamber feed shoe 20 which can be rotated stepwise about the rotation axis 22. A filling apparatus having the reference symbol 36 is associated with the chamber feed shoe 20. The filling apparatus 36 consists of a total of five filling gates 38, whereby with a respective filling gate 38 exactly one filling chamber 24 of the chamber feed shoe 20 can be filled with the corresponding material to be pressed.

Also indicated are a plunger guide 40 for top plungers and a plunger guide 42 for bottom plungers. The illustrated bottom plunger 44 is here positioned in the filling position.

The plunger guide 40 for the top plungers and the plunger guide 42 for the bottom plungers has several segments 44 and 46, respectively, which are arranged consecutively about the periphery. The segments 44 and 46, respectively, smoothly transition into each other, so that a plunger, which is guided along the plunger guide 40 or the plunger guide 42, can move without noticeable resistance along its respective guide track. The plunger guides 40 and 42 are disposed along the entire circumference of the die block 12 and therefore extend also along the pressure rollers 30.

The individual segments 44 and 46 are connected with illustrated drives 52. These drives can be used to displace the segments 44 and 46, respectively, relative to the die block 12, i.e., the spacing can be varied according to the indicated double arrows 50.

The pressure rollers 30 can also be displaced with the indicated drives 52 relative to the die block 12, i.e., away from or towards the die block 12, along the indicated double arrows 50.

The rotary pelleting machine 10 shown in FIG. 2 has, in conjunction with the description of FIG. 1 above, the following functions:

The die 16 located at the filling position is filled through the logically first feed chamber 24 (FIG. 1) of the chamber feed shoe 20 with a powder 56 to be pressed into a first layer forming a multilayer tablet. Filling the dies 16 through a feed shoe is generally known and will therefore not described in detail in the context of the present invention. The powder 56 which now resides in the die 16 is pressed with the bottom plunger 44 and the corresponding top plunger by moving these plungers towards each other along the curve defined by the plunger guides 40 and 42. The plunger stroke of the bottom and top plunger can be different. The plungers are guided past the pressure rollers 30 in a conventional manner, so that the powder 56 is subjected to a defined pressing force and a first layer of the tablet is produced.

After a complete revolution of the die block 12 about 360° the logically next filling chamber 24 is now in the filling position, as described above. Another powder forming the next layer of the multilayer tablet is then filled on the pressed first layer. The second layer is then pressed with the bottom plunger and the corresponding top plunger.

Because the die already contains a first layer made of the powder 56, the stroke of the bottom plunger and/or the top plunger may have to be adjusted differently. To this end, the plunger guides 40 and 42, respectively, are moved relative to the die block 12, thereby changing the plunger stroke. The pressure rollers 30 can be moved relative to the die block 12 in a similar manner, so that a defined pressing force for the second layer can also be set.

The additional layers, according to the exemplary embodiment up to five layers, are filled into the die 16 in a similar manner. The relative position of the plunger guide 40 and/or 42 and/or of the pressure rollers 30 relative to the die block 12 can also be changed depending on the resulting overall height of the already pressed layers.

This illustrates that a five-layer tablet can be pressed during a fivefold revolution of the die block 12. The tablet is then ejected during the sixth revolution, for example, by raising the corresponding segments 46 of the plunger guide 42 so that the tablet is pushed upward by the bottom plungers 44 and out of the dies 16. A logical last chamber of the chamber feed shoe 20 can then be used as a stripper for the pressed tablet.

This illustrates that a relatively small number of multilayer tablets can be produced in a simple manner with a rotary pelleting machine 10 having a small footprint.

The processes described with reference to FIGS. 1 and 2 require synergetic control of the individual components of the rotary pelleting machine. FIG. 3 illustrates the basic process control in form of a block diagram.

FIG. 3 shows a controller 60. The controller 60 can, of course, also perform additional control functions of the rotary pelleting machine which are not of interest in the context of the present invention. The type of multilayer tablets and/or the quantity of multilayer tablets to be produced can be entered into the controller 60 via an input device 62. In particular, the number and layer thickness of the individual layers of the multilayer tablet and the pressing forces to be used for pressing the individual layers can also be defined. For example, a predetermined sequence of control commands corresponding to the prior input entered via the input device 62 can be recalled from a storage device 64. The controller 60 controls the drive 66 of the die block 12. Also controlled is the drive 68 used for rotating the chamber feed shoe 20. At the same time, the feed gates 38 are controlled to selectively refill the individual filling chambers 24 of the chamber feed shoe 20. Also controlled are the drives 52 for adjusting the pressure rollers 30 and the drives 48 for adjusting the respective individual segments 44 and 46 of the plunger guides 40 and 42. Consequently, the participating components cooperate in a synchronized fashion to ensure a continuous process flow.

### LIST OF REFERENCE SYMBOLS

| | |
|---|---|
| 10 | rotary pelleting machine |
| 12 | die block |
| 14 | axis |
| 16 | die |
| 18 | filling apparatus |
| 20 | chamber feed shoe |
| 22 | rotation axis |
| 24 | filling chambers |
| 26 | pressing device |
| 28 | rotation axis |
| 30 | pressure rollers |
| 32 | direction of arrow |
| 34 | direction of arrow |
| 36 | filling apparatus |
| 38 | filling gate |
| 40 | plunger guide |
| 42 | plunger guide |
| 44 | bottom plunger |
| 46 | top plunger |
| 48 | drives |
| 50 | double arrow |
| 52 | drives |

1. Rotary pelleting machine with a driven die block having a defined number of dies distributed over a periphery of the die block, bottom plungers and top plungers associated with the dies and rotating along a bottom plunger guide and a top plunger guide about a common rotation axis synchronous with the die block, with at least one filling apparatus for filling the dies with a material to be pressed, and a pressing device for applying a pressing force to the plungers, characterized in that the filling apparatus (18) has at least two filling chambers (24) which can be filled independent of one another, wherein the filling chambers (24) can be moved sequentially to a defined filling position.

2. Rotary pelleting machine according to claim 1, characterized in that the filling chambers (24) can be moved in the filling position sequentially and continuously during the rotation of the die block (12).

3. Rotary pelleting machine according to claim 2, characterized in that the filling apparatus (18) has at least two sequentially accessible filling chambers.

4. Rotary pelleting machine according to claim 3, characterized in that the filling apparatus (18) is a rotatable chamber feed shoe (20) having at least two filling chambers (24).

5. Rotary pelleting machine according to claim 4, characterized in that the chamber feed shoe (20) has six filling chambers (24) which are arranged in star-shape about a rotation axis (22) of the chamber feed shoe (20).

6. Rotary pelleting machine according to claim 1, characterized in that the chamber feed shoe (20) is operatively connected with a drive which enables in combination a rotary and a linear motion.

7. Rotary pelleting machine according to claim 1, characterized in that a rotary drive of the chamber feed shoe (20) is a drive (48), a pneumatic drive and the like.

8. Rotary pelleting machine according to claim 1, characterized in that the pressing device (26) of the rotary pelleting machine (10) comprises a main pressure roller pair (30).

9. Rotary pelleting machine according to claim 8, characterized in that the pressure rollers (30) are arranged for height adjustment with respect to the die block (12).

10. Rotary pelleting machine according to claim 9, characterized in that the device for height adjustment comprises at least one drive (48), a pneumatic drive and the like.

11. Rotary pelleting machine according to claim 1, characterized in that the guide tracks (40, 42) for the bottom plungers and/or top plungers are height-adjustable relative to the die block.

12. Rotary pelleting machine according to claim 11, characterized in that segments of the guide tracks (40, 42) are height-adjustable independent of one another.

13. Rotary pelleting machine according to claim 11, characterized in that the height adjustment comprises at least one drive (48), a pneumatic drive and the like.

14. Rotary pelleting machine according to claim 1, characterized in that only a single plunger pair associated with the die (16) to be filled is provided.

15. Rotary pelleting machine according to claim 14, characterized in that additional dies (16) of the die block (12) are implemented as dummy dies.

16. Method for producing a multilayer tablet with a rotary pelleting machine, wherein the various layers and/or inserts are introduced in a die of a rotor and pressed, characterized in that the individual layers and/or inserts are introduced in the die sequentially in a continuous process at a common predefined filling position.
